(19) United States
(12) Patent Application Publication
(10) Pub. No.: US 2014/0116240 A1
(43) Pub. Date: May 1, 2014

(54) MULTIFUNCTIONAL CYLINDER AND METHOD FOR CONTROLLING CYLINDER

(71) Applicant: HYUNDAI MOTOR COMPANY, Seoul (KR)

(72) Inventor: Hyun Seop Lim, Anyang-si (KR)

(73) Assignee: Hyundai Motor Company, Seoul (KR)

(21) Appl. No.: 13/714,249

(22) Filed: Dec. 13, 2012

(30) Foreign Application Priority Data
Oct. 31, 2012 (KR) 10-2012-0122375

(51) Int. Cl. F15B 15/14

(52) U.S. Cl. CPC F15B 15/14
USPC 91/166; 91/471

(57) ABSTRACT

A multifunctional cylinder includes: a cylinder housing in which an operating fluid is filled; a rod having one end provided in the cylinder housing and linearly moved in the longitudinal direction of the cylinder housing in accordance with a flow of the operating fluid; and a piston assembly provided at one end of the rod and moved together with the rod and changing a movement amount of the rod per unit time by controlling a passing flow rate of the operating fluid that flows to the other end from one end in the cylinder housing per unit time, and a method for controlling the cylinder.

### CROSS-REFERENCE TO RELATED APPLICATION

The present application claims priority of Korean Patent Application Number 10-2012-0122375 filed Oct. 31, 2012, the entire contents of which application is incorporated herein for all purposes by this reference.

### BACKGROUND OF INVENTION

1. Field of Invention

The present invention relates to a cylinder, and more particularly, to a multifunctional cylinder and a method for controlling the cylinder that implement various operations and functions by controlling a fluid passing amount in the cylinder without using an additional hydraulic driving system part and an advance control technique.

2. Description of Related Art

A hydraulic driver is used in order to generate larger force than an electric driver in the case of a wearable robot which needs to a large load and a hydraulic cylinder which can control a stroke amount illustrated in FIG. 1 is generally used.

Meanwhile, as illustrated in FIG. 2, in the hydraulic cylinder applied to a knee of a robot, the hydraulic cylinder needs to be driven in accordance with a walking pattern of a person largely divided into a contact phase (a)(b), a stance phase (c)(d), and a swing phase (e)(f)(g)(h), and a linear operation type of the cylinder applied to the knee may be divided into a minute operation for shock absorption in the contact phase, a stop state for the stance phase, and a power operation for the swing phase.

Moreover, the linear operation type of the cylinder applied to an ankle of the robot may be divided into the minute operation for shock absorption in the contact phase, a non-power operation for the stance phase, and a power operation for the swing phase.

Like this, an advanced hydraulic control technique is required to implement various steps of operations (minute operation, stop state, and power operation) by using the hydraulic cylinder and in particular, parts such the cylinder, a hydraulic brake, a damper, and the like are required to implement functions for each operation and step, and as a result, an entire system is complicated.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a multifunctional cylinder and a method for controlling the cylinder that implement various operations and functions by controlling a fluid passing amount in the cylinder without using an additional hydraulic driving system part and an advance control technique.

Various aspects of the present invention provide for a multifunctional cylinder including a cylinder housing in which an operating fluid is filled; a rod having one end provided in the cylinder housing and linearly moved in the longitudinal direction of the cylinder housing in accordance with a flow of the operating fluid; and a piston assembly provided at one end of the rod and moved together with the rod and changing a movement amount of the rod per unit time by controlling a passing flow rate of the operating fluid that flows to the other end from one end in the cylinder housing per unit time.

Various aspects of the present invention provide for a multifunctional cylinder including: a first frame and a second frame which connected to hinge-rotate with respect to each other so that a joint operation is possible; a cylinder housing having one end connected to hinge-rotate with respect to the first frame and in which the operating fluid is filled; a rod having the other end provided in the cylinder housing and linearly moved in the longitudinal direction of the cylinder housing in accordance with the flow of the operating fluid; and a piston assembly provided at the other end of the rod and moved together with the rod and changing the movement amount of the rod per unit time by controlling the passing amount of the operating fluid that flows to the other end from one end in the cylinder housing per unit time.

The piston assembly may include: a piston housing fixed to the other end of the rod and moved together with the rod with engaging in the cylinder housing and having a first fluid passing hole partially formed between an axial center and an axial circumference to pass the operating fluid; a motor provided in the piston housing to provide rotational force; and a flow rate control plate provided in contact with an internal end of the piston housing and rotated by receiving the rotational force from the motor, in which a second fluid passing hole is partially formed between the axial center and the axial circumference to correspond to the first fluid passing hole to control the flow rate of the operating fluid passing through the first fluid passing hole and the second fluid passing hole while an area of a part where the first fluid passing hole and the second fluid passing hole overlap with each other during rotation.

The first fluid passing hole and the second fluid passing hole may have the same shape.

the first fluid passing hole may be formed on an end of the piston housing in a circumferential direction in which the flow rate control plate rotates, the second fluid passing hole may be formed in the circumferential direction in which the flow rate control plate rotates, and closed portions may be formed on the sides of the first fluid passing hole and the second fluid passing hole, and as a result, the first fluid passing hole and the second fluid passing hole overlap with the respective closed portions adjacent thereto, respectively to be clogged.

A first inlet and a second inlet for introducing and discharging the operating fluid may be provided at both ends of the cylinder housing, respectively, and the first inlet and the second inlet are connected with the pump, and as a result, the rod may be moved together with the piston assembly while the operating fluid is injected into the cylinder housing from the pump.

Various aspects of the present invention provide for a method for controlling a multifunctional cylinder including: a non-power operation step in which the movement amount of a rod per unit time is maximized by maximizing the passing flow rate of an operating fluid that passes through a piston assembly provided in a cylinder housing per unit time when a non-power operation signal of the cylinder is applied; a damping operation step in which the passing flow amount of the operating fluid that passes through the piston assembly per unit time is further decreased than a maximum value at the time of applying an operation damping signal, and as a result, the movement amount of the rod per unit time is reduced as compared with a maximum movement amount; and an operation restricting step in which the movement of the rod is restricted by restricting the operating fluid not to pass through the piston assembly at the time of applying the operation restricting signal of the cylinder.

The method may further include a power operating step in which the operating fluid is injected into the cylinder housing from the outside while the operating fluid is restricted from passing through the piston assembly at the time of applying the power operating signal of the cylinder to move the rod.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram for describing an operational structure of a hydraulic cylinder in the related art;

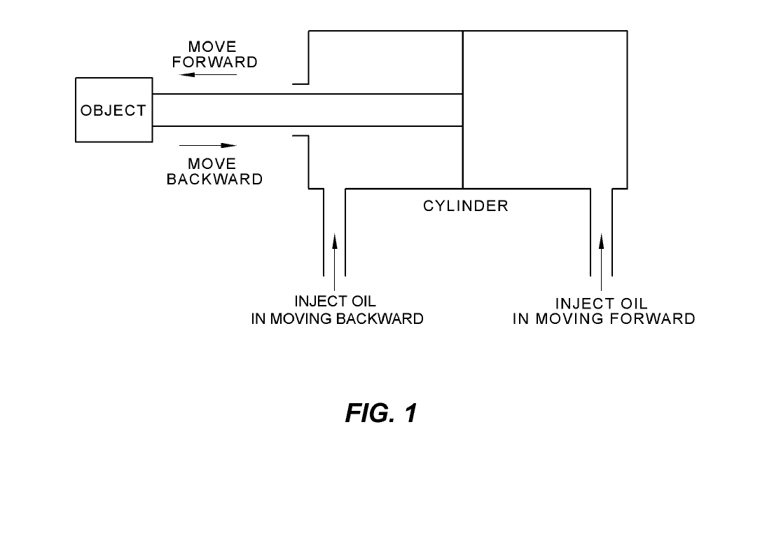

FIG. 2 is a diagram illustrating an operational state of a knee part and a foot part in accordance with a walking pattern of a person;

FIG. 3 is a diagram illustrated by separating a configuration of an exemplary multipurpose cylinder according to the present invention;

FIG. 4 is a diagram for describing a configuration of an exemplary piston assembly according to the present invention;

FIG. 5 is a diagram illustrating an exemplary installation state of the exemplary multipurpose cylinder in joints of the knee part and the foot part and an operational state of the joints;

FIG. 6 is a diagram for describing an exemplary non-power operating state by the exemplary multipurpose cylinder according to the present invention;

FIG. 7 is a diagram for describing an exemplary damping operation state by the exemplary multipurpose cylinder according to the present invention;

FIG. 8 is a diagram for describing an exemplary operation restricting state by the exemplary multipurpose cylinder according to the present invention; and

FIG. 9 is a diagram for describing an exemplary power operating state by the exemplary multipurpose cylinder according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

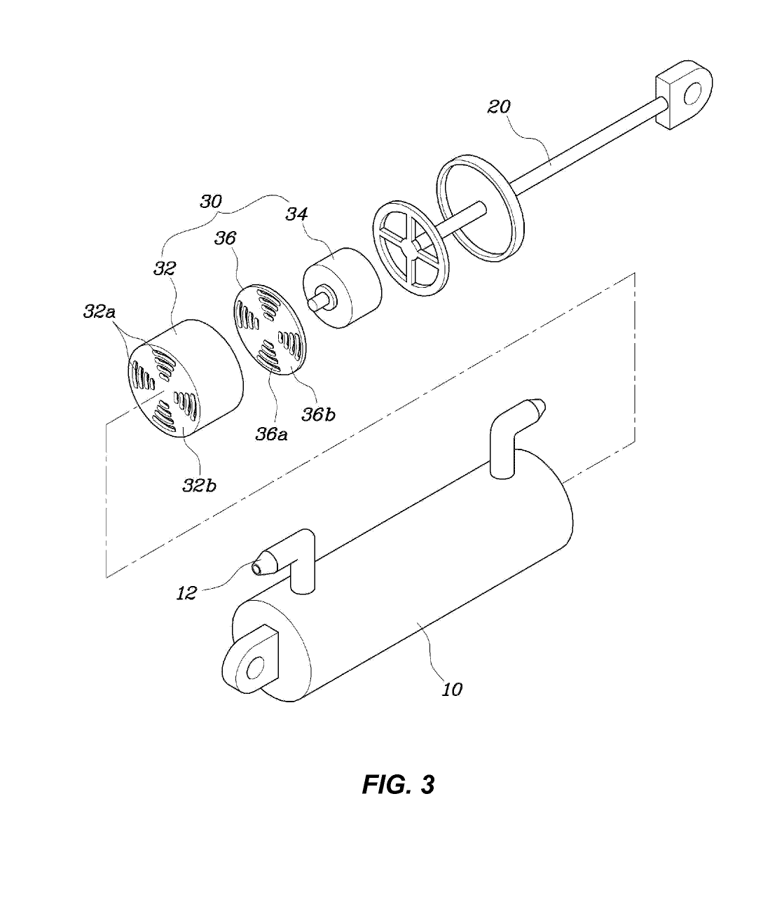

A multipurpose cylinder illustrated through FIGS. 3 to 9 generally includes a cylinder housing 10, a rod 20, and a piston assembly 30.

In detail, the multipurpose cylinder may include the cylinder housing 10 in which an operating fluid is filled; the rod 20 having one end provided in the cylinder housing 10 and linearly moved in the longitudinal direction of the cylinder housing 10 in accordance with a flow of the operating fluid' and a piston assembly 30 provided at one end of the rod 20 and moved together with the rod 20 and changing a movement amount of the rod 20 per unit time by controlling a passing flow rate of the operating fluid that flows to the other end from one end in the cylinder housing 10 per unit time.

Herein, the operating fluid may be oil.

That is, the operating fluid passing amount in the cylinder is controlled and a movement operation of the rod 20 is controlled in accordance with the passing amount of the operating fluid, and as a result, various functions of the cylinder may be implemented and a non-power moving operation, a power moving operation, a shock absorbing (damping) operation, and a stop operation of the rod 20 are performed.

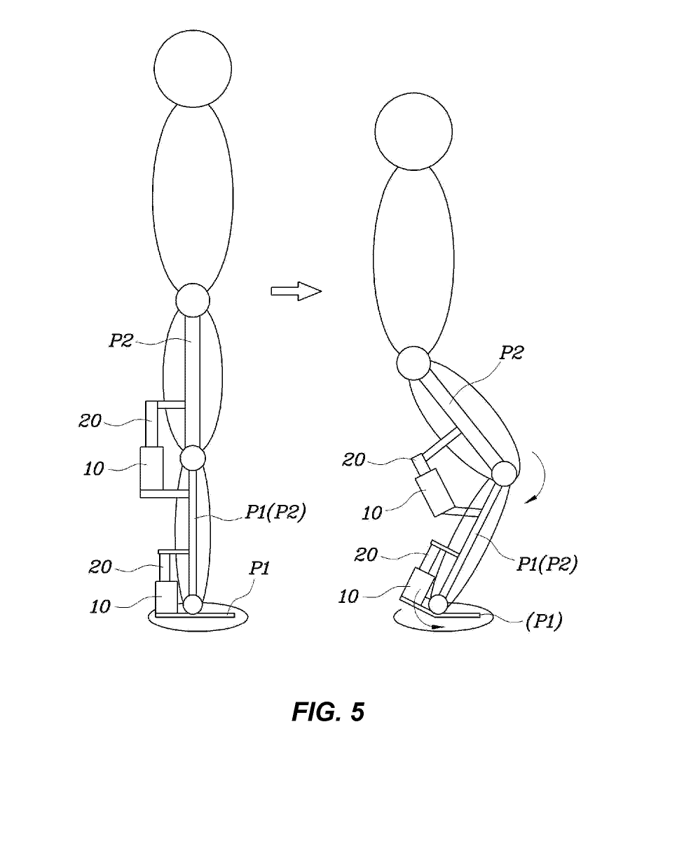

Meanwhile, the multifunctional cylinder of the present invention is applied to joint parts of a robot and as illustrated in FIG. 5, the multifunctional cylinder may be applied to a knee joint part or an angle joint.

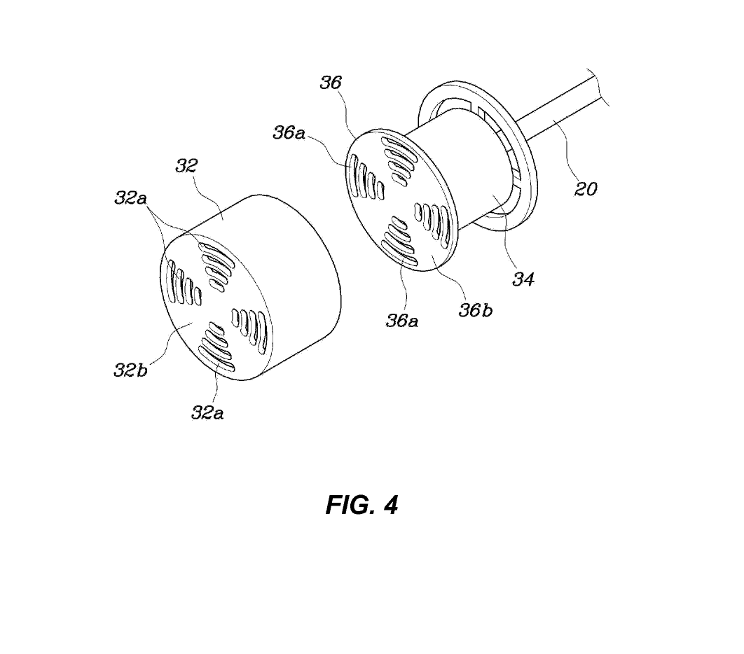

FIG. 3 is a diagram illustrated by separating a configuration a multipurpose cylinder according to the present invention. FIG. 4 is a diagram for describing a configuration of a piston assembly 30 according to the present invention.

Referring to FIGS. 3 and 4, a configuration of the present invention worn on a robot generally includes a first frame P1 and a second frame P2, the cylinder housing 10, the rod 20, and the piston assembly 30.

In detail, the multifunctional cylinder may include the first frame P1 and the second frame P2 which connected to hinge-rotate with respect to each other so that a joint operation is possible, the cylinder housing 10 having one end connected to hinge-rotate with respect to the first frame P1 and in which the operating fluid is filled, the rod 20 having the other end provided in the cylinder housing 10 and linearly moved in the longitudinal direction of the cylinder housing 10 in accordance with the flow of the operating fluid; and the piston assembly 30 provided at the other end of the rod 20 and moved together with the rod 20 and changing the movement amount of the rod 20 per unit time by controlling the passing amount of the operating fluid that flows to the other end from one end in the cylinder housing 10 per unit time.

That is, the first frame P1 and the second frame P2 are configured to relatively rotate with respect to each other while the respective ends of the first frame P1 and the second frame P2 are hinge-coupled with each other so that the joint operation is possible. When further described through FIG. 5, the first frame P1 and the second frame P2 may be frames constituting a femoral part and a calf part of the robot in the case of the knee joint and the first frame P1 and the second frame P2 may be frames constituting the calf part and a top part of a foot of the robot in the case of the ankle joint.

The operating fluid is filled in the cylinder housing 10 in which one end is rotatably hinge-coupled to the first frame P1 and the rod 20 is installed at the other end to be linearly movable in the longitudinal direction thereof

The rod 20 is linearly moved in the longitudinal direction of the cylinder housing 10 while one end is rotatably hinge-coupled to the second frame P2 and the other end engages in the cylinder housing 10. In this case, the rod 20 is movable by various functions in accordance with the flow of the operating fluid filled in the cylinder housing 10. The flow of the operating fluid is varied and changed by a change in flow rate of the operating fluid that passes through the piston assembly 30.

The piston assembly 30 is installed at the other end of the rod 20, that is, the other end of the rod 20 provided in the cylinder housing 10 and is moved linearly together with the rod 20. The movement amount of the rod 20 per unit time is changed by controlling the passing flow rate of the operating fluid that flows to the other end from one end in the cylinder housing 10 per unit time, and as a result, the piston assembly 30 performs various functions with the movement operation of the rod 20.

Operation of various functions may be implemented by controlling the flow rate of the operating fluid that passes through the cylinder without designing and mounting additional parts, and as a result, structural complexity of a cylinder system for a walking operation of the robot is reduced, and a cost and a weight are reduced by decreasing the number of additional parts.

Referring to FIGS. 3 and 4, as the detailed configuration of the piston assembly 30, the piston assembly 30 may include a piston housing 32 fixed to the other end of the rod 20 and moved together with the rod 20 with engaging in the cylinder housing 10 and having a first fluid passing hole 32a partially formed between an axial center and an axial circumference to pass the operating fluid, a motor 34 provided in the piston housing 32 to provide rotational force, and a flow rate control plate 36 provided in contact with an internal end of the piston housing 32 and rotated by receiving the rotational force from the motor 34, in which a second fluid passing hole 36a is partially formed between the axial center and the axial circumference to correspond to the first fluid passing hole 32a to control the flow rate of the operating fluid passing through the first fluid passing hole 32a and the second fluid passing hole 36a while an area of a part where the first fluid passing hole 32a and the second fluid passing hole 36a overlap with each other during rotation.

In this case, a wire for a power and a control of the motor 34 may be incorporated in the rod 20 and rotation of the motor 34 may be controlled outside the cylinder through the wire. Further, the motor 34 may be controlled the robot or an additional control unit (not illustrated) provided outside the robot.

That is, when the flow rate control plate 36 is rotated according to the rotation control operation of the motor 34, the area in which the second fluid passing hole 36a formed on the flow rate control plate 36 and the first fluid passing hole 32a formed in the piston housing 32 overlap with each other is variably controlled according to an angle at which the flow rate control plate 36 rotates. Accordingly, a passing flow rate of the operating fluid per unit time, which passes through an overlapped hole is controlled according to the area where the first fluid passing hole 32a and the second fluid passing hole 36a overlap with each other, and as a result, the movement amount of the rod 20 is controlled together with the piston assembly 30.

Herein, the first fluid passing hole 32a and the second fluid passing hole 36a may have the same shape.

In detail, in the first fluid passing hole 32a, an end of the piston housing 32 has a disk shape and the first fluid passing hole 32a is formed on the disk part in a circumferential direction in which the flow rate control plate 36 rotates. In addition, the flow rate control plate 36 has the disk shape, and as a result, the second fluid passing hole 36a is formed in the disk part in the circumferential direction.

In this case, closed portions 32b and 36b are provided on the sides of the first fluid passing hole 32a and the second fluid passing hole 36a that face the circumferential direction, and as a result, the first fluid passing hole 32a may overlap with the closed portion provided on the side of the second fluid passing hole 36a. In this case, the second fluid passing hole 36a overlaps with the closed portion 32b provided on the side of the first fluid passing hole 32a, and as a result, the first fluid passing hole 32a and the second fluid passing hole 36a may be configured to be clogged.

That is, when the first fluid passing hole 32a and the second fluid passing hole 36a are clogged, the movement operation of the rod 20 stops under a condition that external power is not provided to the operating fluid, and as a result, an operation of supporting the load of the robot may be performed in the joint part.

Meanwhile, while the operating fluid is injected into the cylinder housing 10 through a pump 40 with the control of a flowing rate of the operating fluid that passes through the cylinder, the external power is provided to the rod 20 to move the rod 20. In this case, the pump 40 may be a hydraulic pump 40 using hydraulic pressure.

To this end, a first inlet 12 and a second inlet 14 for introducing and discharging the operating fluid are provided at both ends of the cylinder housing 10, respectively and the first inlet 12 and the second inlet 14 are connected with the pump 40 to, and as a result, the rod 20 may be moved together with the piston assembly 30 while the operating fluid is injected into the cylinder housing 10 from the pump 40.

In this case, the pump 40 may be controlled by an additional control unit provided in the robot or outside the robot and controlled in link with the motor 34.

That is, when hydraulic pressure is provided into the cylinder housing 10 from the pump 40 through the first inlet 12 or the second inlet 14 under a condition that the operating fluid cannot pass through the piston assembly 30, the rod 20 is moved while the piston assembly 30 is pushed and moved by the hydraulic pressure.

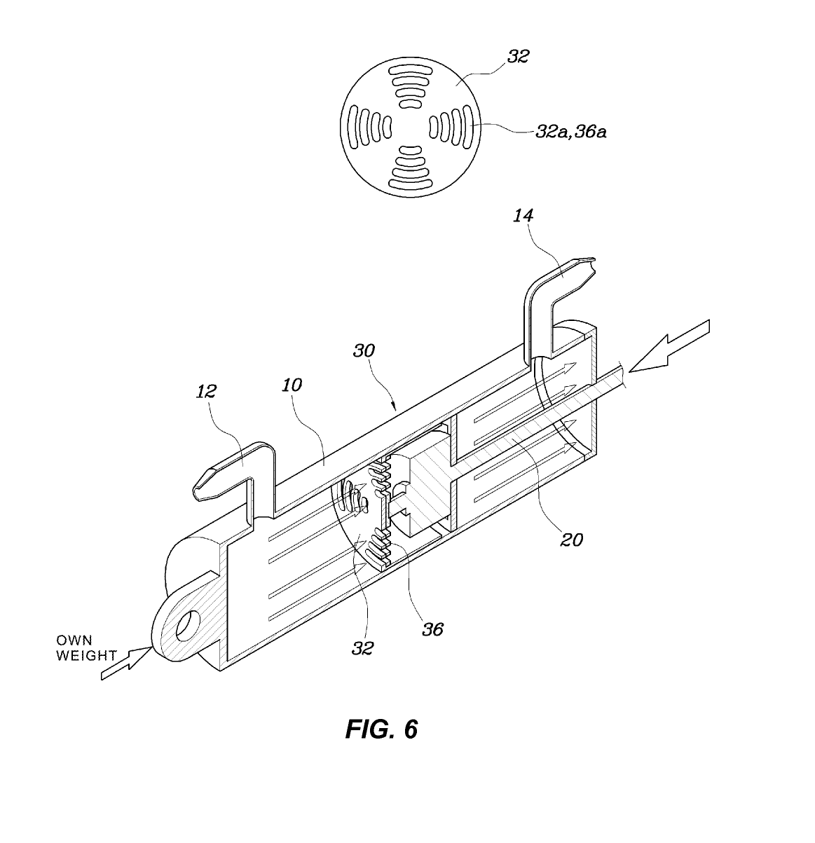

FIGS. 6 to 9 are diagrams illustrating an operational example according to a control method of a multipurpose cylinder of the present invention and the control method of the multipurpose cylinder of the present invention generally includes a non-power operation step, a damping operation step, and a operation restricting step.

FIG. 6 is a diagram for describing a non-power operating state by the multipurpose cylinder according to the present invention.

Referring to FIG. 6, in the non-power operation step, the movement amount of the rod 20 per unit time is maximized by maximizing the passing flow rate of the operating fluid that passes through the piston assembly 30 provided in the cylinder housing 10 per unit time when a non-power operation signal of the cylinder is applied.

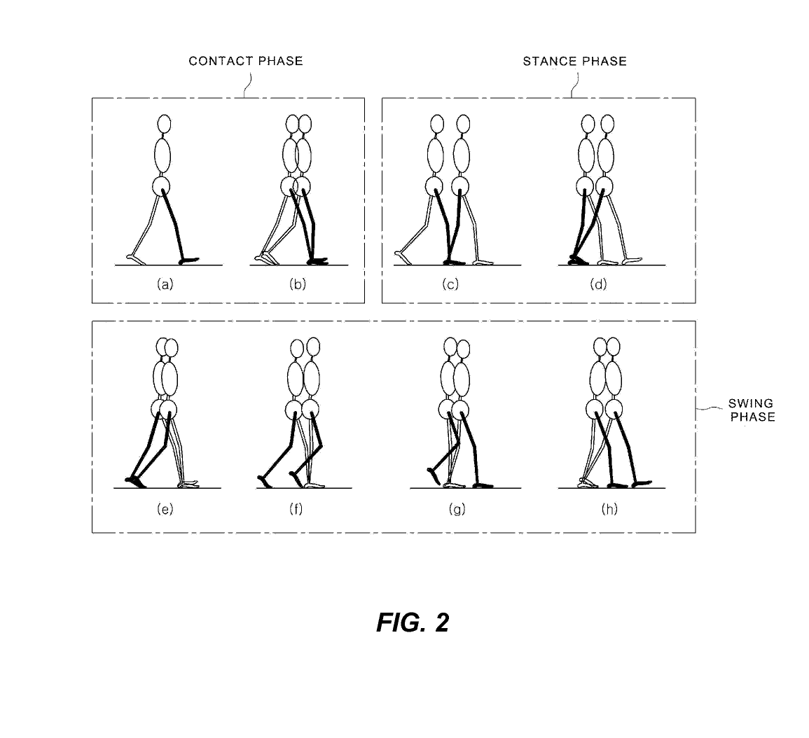

That is, the motor 34 is controlled so that the area where the first fluid passing hole 32a and the second fluid passing hole 36a overlap with each other becomes largest while the hydraulic pump 40 is not driven in the stance phase situation of the angle joint illustrated in FIGS. 2 and 5, and as a result, the passing amount of the operating fluid in the overlapped hole becomes largest and the operating fluid flows smoothly. Therefore, the movement amount of the rod 20 is also increased, and as a result, the rod 20 is rapidly moved. Accordingly, in the non-power operation step, the rod 20 is flexibly moved by an own weight of the robot, and as a result, the joint may be freely rotated with non-power.

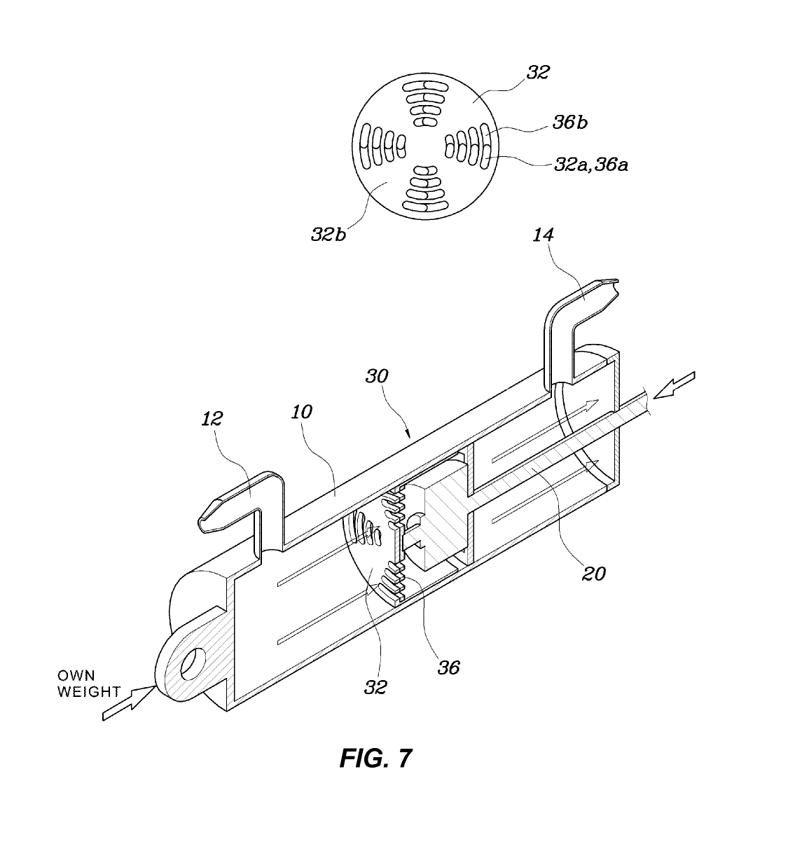

FIG. 7 is a diagram for describing a damping operation state by the multipurpose cylinder according to the present invention.

Referring to FIG. 7, in the damping operation step, the passing flow amount of the operating fluid that passes through the piston assembly 30 per unit time is further decreased than a maximum value at the time of applying an operation damping signal, and as a result, the movement amount of the rod 20 per unit time is reduced as compared with a maximum movement amount.

That is, the motor 34 is controlled so that the area where the first fluid passing hole 32a and the second fluid passing hole 36a overlap with each other becomes largest while the hydraulic pump 40 is not driven in the contact phase situation of the knee and the ankle joint illustrated in FIGS. 2 and 5, and as a result, the passing amount of the operating fluid in the overlapped hole becomes less than the maximum value and the operating fluid flows smoothly. Therefore, the movement amount of the rod 20 is also decreased as compared with the maximum movement amount, and as a result, the rod 20 is minutely moved. Therefore, under the damping operation step, the rod 20 is minutely moved by the own weight of the robot, and as a result, the multipurpose cylinder may be rotated while performing a damping role to absorb shock applied to the joint.

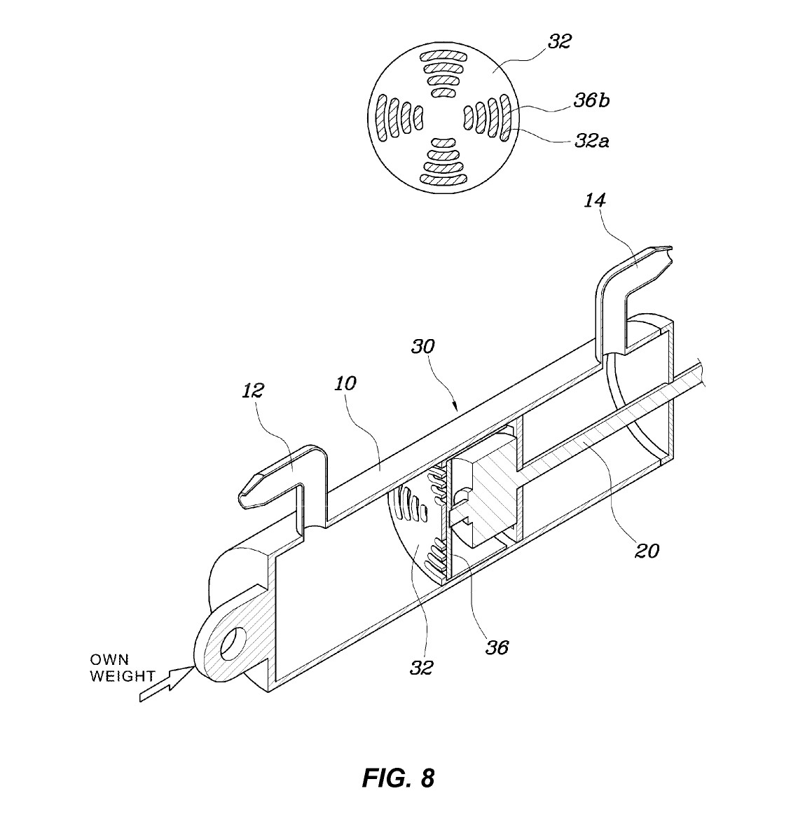

FIG. 8 is a diagram for describing an operation restricting state by the multipurpose cylinder according to the present invention.

Referring to FIG. 8, in the operation restricting step, the movement of the rod 20 is restricted by restricting the operating fluid not to pass through the piston assembly 30 at the time of applying the operation restricting signal of the cylinder.

That is, in the stance phase situation of the knee joint illustrated in FIGS. 2 and 5, the motor 34 is controlled to prevent the first fluid passing hole 32a and the second fluid passing hole 36a from overlapping with each other while the hydraulic pump 40 is not driven, and as a result, the operating fluid may not pass through the hole part. Therefore, the rod 20 may not be moved. Therefore, under the operation restricting step, the movement of the rod 20 is interrupted, and as a result, the multipurpose cylinder serves to support the load of the robot applied to the joint while a rotation operation of the joint is restricted.

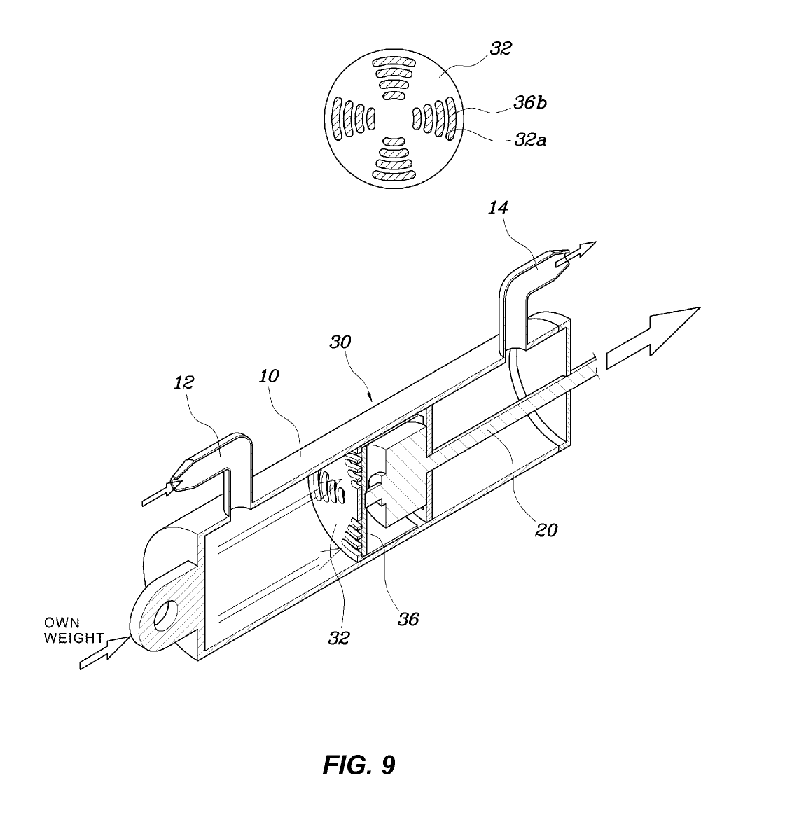

FIG. 9 is a diagram for describing a power operating state by the multipurpose cylinder according to the present invention.

Referring to FIG. 9, in the power operating step, the operating fluid is injected into the cylinder housing from the outside while the operating fluid is restricted from passing through the piston assembly 30 at the time of applying the power operating signal of the cylinder to move the rod 20.

That is, in the swing phase situation of the knee and the ankle joint illustrated in FIGS. 2 and 5, the motor 34 is controlled to prevent the first fluid passing hole 32a and the second fluid passing hole 36a from overlapping with each other while the hydraulic pump 40 is not driven, and as a result, the operating fluid may not pass through the hole part. Therefore, the rod 20 may not be moved by the flow of the operating fluid passing through the hole part. However, the rod 20 is moved by hydraulic pressure by the hydraulic pump 40. Therefore, under the power operating step, the rod 20 is moved by driving the hydraulic pump 40, and as a result, the joint may be rotated by power.

A power operation of a rod through hydraulic pressure is also possible as well as a non-power operation, a damping operation, and a load supporting operation of the rod is implemented by controlling a flow rate at which a fluid passes in a cylinder, and as a result, structural complexity of a cylinder system is reduced by implementing various operations and functions without using additional hydraulic driving system parts and advanced control techniques and a price is saved by reducing the number of additional parts.

Unnecessary power loss is reduced due to the non-power operation function, and the advanced control technique for the damping operation is not required and control logic is simplified. An operation suitable for a walking pattern is possible through controlling a size of a fluid passing hole by a motor to increase robot wearability.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A multifunctional cylinder, comprising:
a cylinder housing in which an operating fluid is filled;
a rod having one end provided in the cylinder housing and linearly moved in the longitudinal direction of the cylinder housing in accordance with a flow of the operating fluid; and
a piston assembly provided at one end of the rod and moved together with the rod and changing a movement amount of the rod per unit time by controlling a passing flow rate of the operating fluid that flows to an other end from the one end in the cylinder housing per unit time.

2. A multifunctional cylinder, comprising:
a first frame and a second frame which are connected to pivot with respect to each other so that a joint operation is possible;
a cylinder housing having one end connected to pivot with respect to the first frame and in which the operating fluid is filled;
a rod having an end provided in the cylinder housing and linearly moved in the longitudinal direction of the cylinder housing in accordance with the flow of the operating fluid; and
a piston assembly provided at the end of the rod and moved together with the rod and changing the movement amount of the rod per unit time by controlling the passing amount of the operating fluid that flows to the end of the rod from the one end in the cylinder housing per unit time.

3. The multifunctional cylinder of claim 2, wherein the piston assembly includes:
a piston housing fixed to the end of the rod and moved together with the rod with engaging in the cylinder housing and having a first fluid passing hole partially formed between an axial center and an axial circumference to pass the operating fluid;
a motor provided in the piston housing to provide rotational force; and
a flow rate control plate provided in contact with an internal end of the piston housing and rotated by receiving the rotational force from the motor, in which a second fluid passing hole is partially formed between an axial center and an axial circumference to correspond to the first fluid passing hole to control the flow rate of the operating fluid passing through the first fluid passing hole and the second fluid passing hole while an area of a part where the first fluid passing hole and the second fluid passing hole overlap with each other during rotation.

4. The multifunctional cylinder of claim 3, wherein the first fluid passing hole and the second fluid passing hole have the same shape.

5. The multifunctional cylinder of claim 3, wherein the first fluid passing hole is formed on an end of the piston housing in a circumferential direction in which the flow rate control plate rotates, the second fluid passing hole is formed in the circumferential direction in which the flow rate control plate rotates, and closed portions are formed on the sides of the first fluid passing hole and the second fluid passing hole, and as a result, the first fluid passing hole and the second fluid passing hole overlap with the respective closed portions adjacent thereto, respectively to be clogged.

6. The multifunctional cylinder of claim 2, wherein a first inlet and a second inlet for introducing and discharging the operating fluid are provided at opposing ends of the cylinder housing, respectively, and the first inlet and the second inlet are connected with the pump, and as a result, the rod is moved together with the piston assembly while the operating fluid is injected into the cylinder housing from the pump.

7. A method for controlling a multifunctional cylinder of claim 1, comprising:
a non-power operation step in which the movement amount of a rod per unit time is maximized by maximizing the passing flow rate of an operating fluid that passes through a piston assembly provided in a cylinder housing per unit time when a non-power operation signal of the cylinder is applied;
a damping operation step in which the passing flow amount of the operating fluid that passes through the piston assembly per unit time is further decreased than a maximum value at the time of applying an operation damping signal, and as a result, the movement amount of the rod per unit time is reduced as compared with a maximum movement amount; and
an operation restricting step in which the movement of the rod is restricted by restricting the operating fluid not to pass through the piston assembly at the time of applying the operation restricting signal of the cylinder.

8. The multifunctional cylinder of claim 7, further comprising
a power operating step in which the operating fluid is injected into the cylinder housing from the outside while the operating fluid is restricted from passing through the piston assembly at the time of applying the power operating signal of the cylinder to move the rod.
